(19) United States
(12) Patent Application Publication
(10) Pub. No.: US 2006/0233148 A1
(43) Pub. Date: Oct. 19, 2006

(54) System and method of voice transmission from mobile data networks

(76) Inventor: Zheng John Shi, Tiburon, CA (US)

Correspondence Address: ZHENG J. SHI, 336 BLACKFIELD DRIVE, TIBURON, CA, 94920, US

(21) Appl. No.: 11/108,111

(22) Filed: Apr. 18, 2005

(51) Int. Cl. H04B 7/216

(52) U.S. Cl. 370/342

(57) ABSTRACT

The present invention permits the real-time transmission of voice from a networked device via a mobile data network to a mobile phone handset, without the involvement of broadband wireless networks such as Bluetooth, WI-FI or WIMAX. Currently, much work has been done to enable VoIP communication via the WI-FI protocol. WI-FI access requires the mobile handset supporting WI-FI feature, and the presence of WI-FI gateway, typically installed in hot spots such as airport or coffee shops. This is not ideal as the combination of these two criteria means that only a small fraction of the handsets that support WI-FI can make such VoIP calls and only when the users are within a hot spot. The present invention eliminates these limitations and enables voices to be transmitted from the mobile data network directly into a mobile phone whenever and wherever there is mobile phone dial tone.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates generally to transmitting voice over mobile data networks, and more particularly, to a system and method of transmitting voice from a mobile phone to a networked device via a mobile data network.

2. Description of the Related Art

Generally speaking, voice is transmitted from one mobile phone to another, via the voice channel of mobile phone networks. These voice networks have been built over time and are primarily dedicated for transmitting voice only.

With the advent of new technologies and new networks such as the Internet and the wireless Internet it has become possible for the mobile phone to connect to the Internet directly, for example, if the mobile phone supports WI-FI and if the Internet access is available via a WI-FI (Wireless Fidelity) gateway. The major advantages of such voice transmission via the Internet and WI-FI are:
1. Low cost. Dedicated voice channels and networks have required very large investments to be made over the years to build. So there are few network operators to choose from and cost is high. With WI-FI and the Internet, voice communication networks can be built overnight with the existing WI-FI and Internet infrastructure and at much lower cost. From a consumer standpoint, wireless voice communications via WI-FI would eliminate the need to pay high prices to wireless voice communication service providers and allow customer to choose from may more providers.
2. Value-added services. Once the voice communication has become digitized and is transmitted via the data networks, other value-added services can be easily built on top of the voice communications, such as voice recording, indexing, searching, and sharing, and exchanges of files of any format together with the voice communications.
   One disadvantage of utilizing technologies such as WI-FI to implement VoIP for mobile telephony is that it requires the mobile phone to support such WI-FI feature. At the present moment, the vast majority of mobile phones do not have features to support WI-FI. Another disadvantage of utilizing WI-FI to implement VoIP for mobile telephony is that it requires the presence of a WI-FI gateway to connect that mobile handset to the Internet. While WI-FI gateways have sprung up across the US and much of the developed worlds such as South Korea and the Nordic countries, in the so-called “hot spots” such as hotels, coffee shops and airports, they are the exceptions rather than the rules. Most of the time the users of a mobile phone will find themselves not within a hot spot. Thus, VoIP with the WI-FI method does not appear to be able to meet the needs of most mobile users most of the time.

From the discussion above, it should be apparent that there is a need for better method of transmitting voice from a mobile phone to a networked server, specifically, a method that captures voice from the mobile phone handset and transmit it via a wireless data network rather than the traditional voice communication networks. The present invention fulfills this need.

### BRIEF SUMMARY OF THE INVENTION

The present invention permits the transmitting of voice to a networked device via a mobile data network, from a mobile phone handset, such as a Nokia 7610 handset running the Symbian operating system, in the form of a data file, without the voice or the data file having to go through the voice channel of telephone networks.

Other features and advantages of the present invention should be apparent and will be better understood by reference to the drawings and the following detailed description, which illustrate, by way of example, the principles of the invention.

### DETAILED DESCRIPTION OF THE INVENTION

The present invention outlines a system and provides several implementations for transmitting voice between two mobile phones via a mobile data network, without having to go through the voice channel of traditional phone networks and without having to use WI-FI to access the Internet. It is a system that allows voice to be transmitted to a networked server at any time and anywhere there is mobile data network coverage, such as GPRS or CDMA.

System Configuration

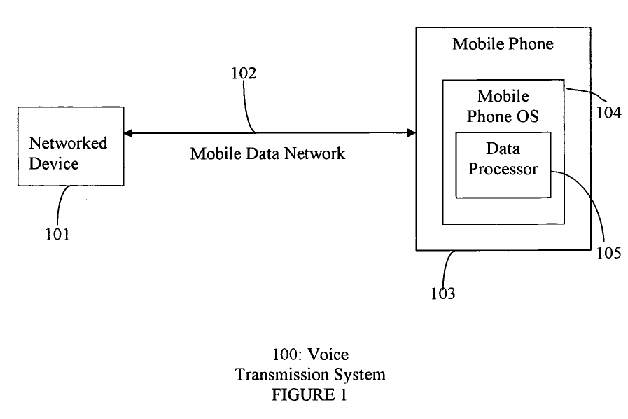

FIG. 1 shows a system 100 consisting of a networked device 101, a mobile data network connection 102, a mobile phone 103, running an advanced mobile phone operating system 104, data processor 105 runs on top of the mobile operating system 104. The mobile phone receives digitized voice from a network device. The data processor converts the digital file into voice.

System Implementation

Embedded in the hardware of a mobile phone is the capability to convert digitized voice into the natural voice. An advanced mobile phone operating system can also receive such digitized voice data files from a mobile network, if the IP address is known. Therefore, such digitized voice data file can be received from a networked device with an IP address, and converted into voice with standard Application Programmable Interfaces (APIs) provided by an advanced mobile phone operating system.

Because of the fact that currently the Symbian operating system has a high market share among all advanced operating systems, we will use it as an example to implement our system and method. Similar implementation can be achieved with other advanced mobile phone operating systems such as those from Microsoft and Palm.

First, we will create a data file of 1 kilobyte in size, and make it the buffer of the data exchange and conversion:

Function CreateFileBuf(FileName)
{

_LIT(KFilename,FileName);
RFile File;
File.Create(fsSession,KFilename,EFileWrite| EfileWrite|
EFileStream);
File.SetSize(1024);

}

Then, we will receive the digitized voice data file from a networked device, whose IP address is x.y.z.w. To do this, the mobile phone will establish a socket connection, receive the digitized voice data file and store it in the above mentioned data buffer file:

Function CreateSocket( )
{

RSocketServ SocketServ;
RSocket Socket;
SocketServ.Connect( );
Socket.Open(SocketServ, KAfInet, KSockStream,
KProtocolInetTcp);

Then, we will create an object iMdaAudioPlayerUtility to instantiate the CmdaAudioPlayerUtility class, open the stored data file and convert it to voice that is played by the mobile phone's embedded speaker:

```
  Function PlayFileToVoice (FileName)
  {
  _LIT(KFilename,FileName);
  iMdaAudioPlayerUtility ->OpenFileL(KFilename);
  iMdaAudioPlayerUtility ->Play();
iMdaAudioPlayerUtility ->Close();
  }
```

We claim:

1. A method for transmitting voice from a networked device to a mobile phone that runs an advanced operating system, the method comprising:
receiving, by a networked device, a digitized voice signal originated from a user of a mobile phone;
sending, the said digitized voice signal to a mobile phone that runs an advanced operating system;
converting, the said digitized voice signal into voice,
wherein the receiving and sending actions are accomplished via a mobile data network, without involving BlueTooth, WI-FI or WI-MAX technologies.

2. A method as defined in claim 1, wherein the said mobile data network is based on GPRS.

3. A method as defined in claim 1, wherein the said mobile data network is based on CDMA.

4. A method as defined in claim 1, wherein the said mobile data network is based on EDGE.

5. A method as defined in claim 1, wherein the said mobile data network is based on CDMA2000.

6. A method as defined in claim 1, wherein the said mobile data network is based on TD-SCDMA.

7. A method as defined in claim 1, wherein the said mobile data network is based on WCDMA.

8. A method as defined in claim 2, 3, 4, 5, 6 and 7, wherein the said advanced operating system is the Symbian mobile phone operating system.

9. A method as defined in claim 2, 3, 4, 5, 6 and 7, wherein the said advanced operating system is the Microsoft mobile phone operating system.

10. A method as defined in claim 2, 3, 4, 5, 6 and 7, wherein the said advanced operating system is the Palm mobile phone operating system.

11. A method as defined in claim 2, 3, 4, 5, 6 and 7, wherein the said advanced operating system is the Embedded Linux mobile phone operating system.

12. A method as defined in claim 2, 3, 4, 5, 6 and 7, wherein the said advanced operating system is other Graphical User Interface (GUI) based mobile phone operating systems.

13. A method as defined in claim 8, 9, 10, 11 and 12, wherein the said networked device is a mobile phone.

13. A method as defined in claim 8, 9, 10, 11 and 12, wherein the said networked device is a computer.
